(19) United States
(12) Patent Application Publication
(10) Pub. No.: US 2009/0260070 A1
(43) Pub. Date: Oct. 15, 2009

(54) Systems and Methods for Secure Sign-Up Procedures for Application Servers in Wired and Wireless Environments

(75) Inventor: Hesham Soliman, Melbourne (AU)

Correspondence Address: CROWELL & MORING LLP;INTELLECTUAL PROPERTY GROUP, P.O. BOX 14300, WASHINGTON, DC, 20044-4300, US

(73) Assignee: Elevate Technologies Pty Ltd., Melbourne (AU)

(21) Appl. No.: 12/423,058

(22) Filed: Apr. 14, 2009

Related U.S. Application Data
(60) Provisional application No. 61/044,981, filed on Apr. 15, 2008.

(51) Int. Cl. H04L 9/32

(52) U.S. Cl. 726/8

(57) ABSTRACT

Systems and methods of providing strong authentication for a client device to sign-up with an online service. Authentication can involve verifying user's identity, message authentication, message integrity and nonrepudiation. The security procedures may, in some cases, be sufficient to verify all of these parameters. In other cases, the sign-up procedure needs to be combined with other information in order to verify the user's real identity.

The present application claims priority under 35 U.S.C. § 119 to U.S. Provisional Application No. 61/044,981, filed Apr. 15, 2008, the entire disclosure of which is herein expressly incorporated by reference. The present application is related to U.S. Provisional Application No. 60/915,509, filed May 2, 2007 and U.S. patent application Ser. No. 12/110,471, filed Apr. 28, 2008, the entire disclosure of the aforementioned applications is herein expressly incorporated by reference.

### BACKGROUND OF THE INVENTION

The ubiquitous deployments of wireless systems (of different technologies) and the use of personal wireless devices form a strong base for the deployment of several new services that utilize such deployments. Many new services are being introduced or discussed in the context of wireless systems. These services include Tele-medicine and Wellness services, financial services, gaming, sensor networks and the like. Telemedicine services involve the remote monitoring of patient's health through the use of a medical device that tracks the relevant body functions and a transmission device that receives medical information and sends it to a remote location. Such medical information can also be stored for future reference by a physician, a paramedic or by the patient. A patient can also enter (manually or automatically) other information about his diet and other medical conditions that are not being monitored to give a complete view of his health. A “Wellness” service involves (but is not limited to) the monitoring and storage of personal and body functions information about a person who is not a patient. Such service might be used for general well-being, to monitor important body functions and parameters (e.g. weight, blood pressure, heart rate), or it can be used by athletes and sports enthusiasts to keep a record of their training, performance and their bodies' reactions during a training session or competition. Furthermore, wellness covers people's nutritional intake.

### SUMMARY OF THE INVENTION

Many of the services discussed above are greatly enhanced with a secure way of initial sign-up for the service, as well as, securing future communication between the application client and the application server. This is particularly important for services that require strong confidentiality and authentication such as medical services and financial services. Exemplary telemedicine and wellness services are disclosed in U.S. patent application Ser. No. 12/110,471, filed on Apr. 28, 2008.

Most of today's internet services rely on a weaker type of security for providing online access. Such security generally falls into two main schemes: password-based or server-only authentication. Password-based authentication schemes rely on the use of a username and a password to allow the user access to a secure site. Server-only authentication is typical in most password-based schemes on the Internet. In this scenario the client's application (e.g. a web browser) is able to verify the identity of the server based on verifying the server's public key, which is typically signed by a known certificate authority whose certificate was previously configured in the client's software module (e.g. a web browser). However, such mechanism does not allow the se rver to verify the identity of the client. As a result, the server relies on the user entering a password to be authenticated. However, password-based schemes are generally weak as passwords can be broken by someone monitoring the user's traffic through brute-force attacks or more conveniently through dictionary based guessing attacks in a relatively short time. Hence, there is a need for stronger mutual authentication between the client and the server.

This invention presents a number of mechanisms that can be used to provide strong mutual authentication between a client and a server based on the user's credentials. Such mechanisms will be particularly useful for applications where users, service providers and regulators require strong authentication and confidentiality for the service to be successful.

This invention presents a number of different mechanisms that can be used by a client device to sign-up for an online service requiring strong authentication. Three different methods are proposed that are suited to different deployment scenarios. These methods are well suited to services that require a high level of security, like medical and health services. An online medical server can be used to store all users' medical records. Records can be uploaded manually through a user's computer or mobile phone. Alternatively, records can be updated automatically and continuously by connecting a medical device to a user's computer or mobile phone. Hence, there is a need to make sure that users' data can be exchanged in a secure manner. Given that records may be updated or downloaded for viewing at any time by a user, confidentiality is a key requirement for medical systems. In order to keep user's information confidential, it is critical that access to those records is done using strong authentication, where simple brute force attacks to get the user's secret authenticators will not work. In order to do that, users must be able to sign up for the service in a secure manner. It is critical that the following parameters are verified: user's identity, message authentication, message integrity and nonrepudiation. The security procedures shown in this invention may in some cases be sufficient to verify all of these parameters. In other cases, the sign-up procedure needs to be combined with other information in order to verify the user's real identity. The various verification steps are detailed in this invention.

An exemplary method of generating information for secure data exchange with an application server involves performing, by a client device, an authentication with an authentication server of a wireless communication network; sending, by the client device, a signup message to the application server, the signup message includes a signup form and a requested username; receiving, by the client device, a signup acknowledgement message from the application server, the signup acknowledgement message includes an accepted username and a root key; and storing, by the client device, the accepted username and root key, wherein the accepted username and root key are employed for secure data exchange with the application server and the application server and client device do not have a prior security relationship.

The method can also involve generating, by the client device, an application-specific key using information obtained from the authentication with the authentication server. The application-specific key can be generated by generating a hash value from a session key from the authentication with the authentication server and an application label. The authentication server can generate an application-specific key using information obtained from the authentication with the authentication server and provides the application-specific key to the application server. The signup message can include a nonce. When the requested username is already reserved, the accepted username received in the signup acknowledgement message can also include a list of suggested usernames. The signup form can include a billing method and payment information. The signup acknowledgement message can also include an authentication method for the secure data exchange.

Another exemplary method of generating information for secure data exchange with an application server involves obtaining, by a client, a certificate for an application associated with the secure exchange of data; generating, by the client, a key; sending, by the client to the application server, a signup message to an application server, the signup message including the generated key, a requested username and a requested password; receiving, by the client from the application server, a signup acknowledgement message, the signup acknowledgement message can include an accepted username, an accepted password and a certificate for the secure data exchange.

The key generated by the client can be a public key or a root key. The signup message can also include a user information form. The user information form can also include a billing method and payment information. When the requested username is already reserved, the accepted username received in the signup acknowledgement message can also include a list of suggested usernames. The signup acknowledgement message can also include an authentication method for the secure data exchange.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a block diagram of an exemplary network in accordance with the present invention;

FIG. 2 is a call flow diagram of an exemplary method in accordance with one aspect of the present invention;

FIG. 3 is a call flow diagram of an exemplary method in accordance with another aspect of the present invention; and

FIG. 4 is a call flow diagram of an exemplary method in accordance with yet another aspect of the present invention.

### DETAILED DESCRIPTION OF THE PREFERRED EMBODIMENTS

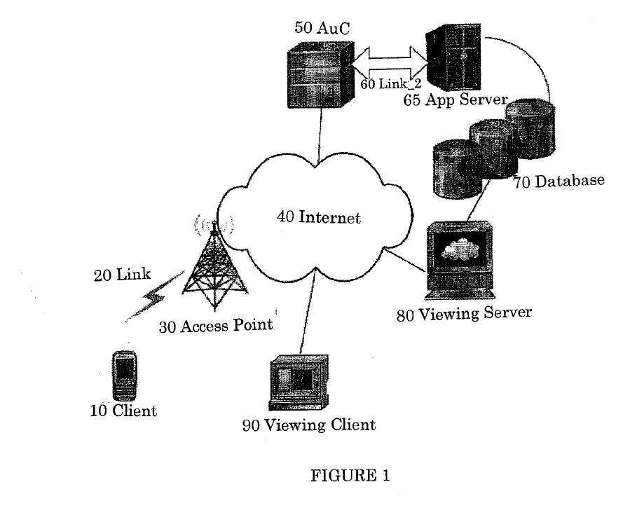

As illustrated in FIG. 1, the system contains a Client Device (10) that can communicate with the Authentication Centre (AuC, 50). The Client device is connected to the Internet (40) via a link (20) and an Access Point (30). The link 20 may consist of a wired or wireless medium. The Access Point 30 comprises hardware that can receive the client 10 data and forward it to the Internet 40. The AuC 50 is connected to an Application Server 65, which controls a Database 70 through Link_2 60. Link_2 60 may be a wired or wireless media and may include zero or more data forwarding devices (e.g. routers or switches). Client device 10 can be any type of device capable of wired and/or wireless communication, including, but not limited to, a wired or wireless telephone, wired or wireless personal digital assistant (PDA), laptop computer, desktop computer, wireless pager and/or the like.

The Database 70 contains user's application-specific identity and the corresponding credentials that should be used to access the user data that are also stored in the database 70. The application server 65 is an application that requires secure sign-up procedures due to its access to critical and confidential user data (e.g. online health application containing medical and health records). The user is expected to administer or control the client device. The viewing server 80 is used to allow users to view their data. In order for users to view their data, they connect to the server information in a secure manner. Note that the Client 10 and the viewing client 90 represent functional modules that can be integrated in one physical device, or implemented in two different physical devices.

In order to maintain the security requirements of a medical application, it must be possible for the AuC and the viewing server to perform mutual authentication with the Client 10 and the viewing client 90, respectively. Furthermore, data exchanged must be authenticated and encrypted. To achieve this goal, it is critical that the sign-up procedure is done in a secure manner so that it can be used to create credentials that can be used by the user, whether on the client 10 or the viewing client 90 to exchange information with the AuC 50 in order to access the application server 65 and the database 70 or the viewing server 80.

### Method 1: Leveraging Cellular Infrastructure Security for Sign-Up Procedures

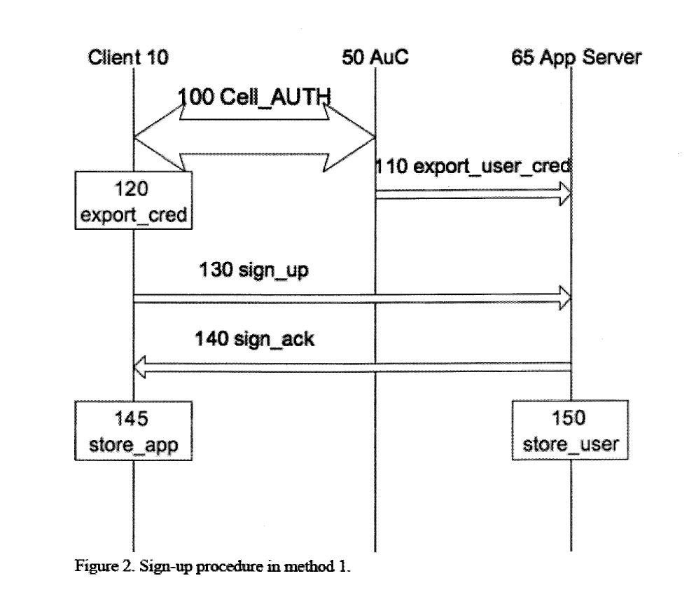

The third generation of cellular systems (e.g. 3GPP) already uses mutual authentication based on pre-shared credentials in the mobile terminal and the network's authentication entity hereafter referred to as the AAA server. The AAA server and AuC 50 are used synonymously within this invention to represent an authentication, authorization and accounting server. Such credentials can be used to bootstrap application specific credentials that can be used by the Client 10 and the AuC 50 to allow the client to sign-up for a service and permanently store an application-specific identity for that client and the corresponding security keying material that can be used by the client to later authenticate itself to the application server and vice-versa. In this case, the application server 65 can be assumed to control the database 70 shown earlier in FIG. 1. Hence, by leveraging the existing trust in a cellular network between the client 10 and the AAA server, a new pre-shared key and application-specific identity can be created and later used for secure communication between the client 10 or the viewing client 90, and the application server 65 or the viewing server 90, respectively. Application server 65 and client 10 do not have a prior security relationship. FIG. 2 shows the message flow for the sign-up

The message exchange 100 Cell_AUTH represents the mechanism used within the cellular system to mutually authenticate the mobile device to the network's AAA server. Several mechanisms are currently used to mutually authenticate the mobile device and the AAA server. These mechanisms include those defined by 3GPP and 3GPP2 systems, or others that utilize the Extensible Authentication Protocol (EAP) (RFC 3748) like EAP-AKA (RFC 4187) or other EAP methods.

As a result of the above 100 Cell_Auth message exchange, an application-specific key can be generated. A number of different documented methods may be used to generate the application-specific key. A commonly documented method uses the application name as a label that can be incorporated with, among other parameters, a session key generated as a result of the exchange, to produce the application-specific key. For an online health application the following can be used:

Kₒₙₗᵢₙₑ=Hash(Session_key,“onlinehealth”,param1,param2)

where Kₒₙₗᵢₙₑ is the online health's application key, “onlinehealth” is a label specific to this application and known by both the AuC 50 and the Client 10, param1 and param2 are two optional parameters that are known to both the AuC 50 and the Client 10 either through an encrypted exchange or in a pre-configured manner.

After successfully performing mutual authentication, the AuC sends the export_user_cred message 110 to the online health application server 65. This message contains the following information:

User's initial identity. This is the same identity used by the user to authenticate to the AuC 50. Alternatively, a new identity generated during the 100 Cell_Auth exchange may be used provided that such identity is known to the Client 10 and the AuC 50.

User's application-specific key

User's information template. This parameter includes a number of fields that include the user's information, like billing address, name and date of birth. The template may be different for different applications.

Authentication and Encryption headers. These headers ensure that the client's key and information are not exposed to other malicious parties.

The Client 10 exports the user's credentials using an internal Export_cred 120 message to the application-specific module within the client 10. This message informs the receiving software module of the user's identity for authenticating to the application server 65. Additionally, it informs the application module of the user's security keys that should be used to authenticate messages to the application server 65.

Following the reception of the application-specific credentials, the application running on the client 10 sends the sign up message 130 to the application server 65. This message contains the following information:

The user's identity provided in the export_cred 120 message.

A Sign-up form. This form includes information about the user. This form need not match the information template provided in the export_user_cred message 110. The Sign-up form may contain additional information about the user including billing method, credit card information, and so on. This information may be manually input by the user through an application interface on the client 10.

A nonce, which is a number or bit string used only once. The purpose of the nonce is to authenticate the receiving application server 65. Since this message is encrypted, if the application server 65 can return the nonce value, or a derivative of the nonce, then it proves its possession of the user's credentials.

A requested username that the user chooses in order to access the application.

Authentication and encryption headers. This message is authenticated and encrypted using the credentials provided in the export_cred 120 message.

Following the reception of the sign-up 130 message, the application server 65 verifies the message. If the message does not compute correctly, it is silently discarded. Otherwise, the sign_ack 140 message is sent to the client. The sign_ack 130 message includes the following information:

Indication of success or failure and reason. Failure indicates that the procedure needs to be repeated.

The accepted username for the user. If the user's choice was already taken, this field contains a list of suggestions for the user. The user can either accept one or try a new username. In the case where the username originally suggested in the sign-up 130 message already taken, the sign-up procedure needs to be repeated with the new username.

The nonce sent in the sign_up 130 message, incremented by 1.

The Root key. This is a new key derived by the server. The Root key represents the permanent security relation between the application on the client 10 and the application server 65. It must be stored in non-volatile memory by the application.

The authentication method that should be used by the client in future to start a secure session. Such method may indicate, for example, EAP methods, The Internet Key Exchange (IKE) (RFC 4306) or any other proprietary method.

Authentication and encryption data. This message is authenticated and encrypted using the same keying material that the client used in the sign_up 130 message.

Following a successful sign-up procedure, the username and the Root key are stored in the client 10 using the store_app 145 procedure. Similarly, the username and Root key are stored by the application server 65 on the database 70 using the store_user 150 procedure.

At this point both the client 10 and the application server 65 have the necessary information to exchange data in a secure manner.

### Method 2: Using Asymmetric Security

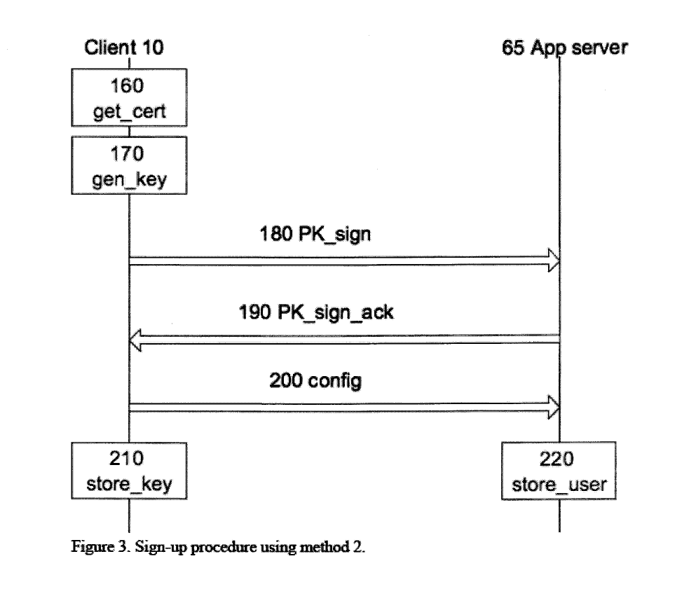

This method does not rely on a mediating AAA server acting as a trusted third party between the client 10 and the application server 65. When using this method, the client discovers the address of the application server 65. This can be done using the Domain Name System (DNS) or through various other means. Upon discovering the address. The client initiates the message sequence shown in FIG. 3.

After discovering the IP address of the application server 65, the client proceeds to get the certificate of that application in the get_cert 160 procedure. Retrieving the certificate is a typical action similar to that done by web browsers when a user is accessing a secure site. The certificate is typically an X.509 certificate or another format that includes the application server's public key and is signed by a trusted party, including the certificate authority of the domain running the application server 65. The certificate may also come with a software program that the client downloads in order to sign-up for the application.

Upon verifying that the certificate is signed by a trusted certificate authority, the client proceeds to generate a public/private key pair using, for example, using RSA keys. This is done using the gen_key 170 procedure. Following the generation of the key pair, the client 10 sends the PK_sign 180 message to the application server 65.

The PK_sign 180 message includes the following information:

The Public key generated in the gen_key 170 procedure.

The user's information form. This form includes billing method, credit card information, and so on. This information may be manually input by the user through an application interface on the client 10.

A requested username to be associated with the public key. This is a suggestion that may be accepted or rejected by the application receiving this message.

A requested password. The client should ensure that the password complies with the receiving application's requirements for password formats.

Authentication and encryption headers. The message is encrypted by the public key of the application server 65, which was received after the get_cert 160 procedure. The message is authenticated using the private key generated by the client 10 in the gen_key 170 procedure.

Upon processing the PK_sign 180 message, the application server 65 sends the PK_sign_ack 190 message. This message includes the following parameters:

Indication of success or failure

The accepted username. This parameter indicates whether the username sent by the client 10 was accepted. If that username were not accepted, a list of suggested usernames is sent in this parameter. The client 10 can then choose to accept one of those suggested names or re-send the PK_sign message again. If one of the suggested usernames were accepted, it will be included in the Config 200 message.

A certificate for the client 10 to use in future when starting a secure session with the application server 65. This certificate includes the client 10's public key, and some meta data about the client that the application needs to add. The certificate is signed by the certificate authority running the application's domain or another trusted certificate authority.

The authentication method that should be used by the client in future to start a secure session. Such method may indicate, for example, EAP methods, IKE or other standard or proprietary mechanisms. Upon receiving the PK_sign_ack 190 message, the client 10 checks whether the username it sent in the PK_sign 180 message. If the username were accepted or if the client 10 decides to accept one of the usernames suggested in the message, it sends the Config 200 message. Otherwise, it sends the PK_sign message 180 with a new username. The Config 200 message includes the following parameters:
The username accepted by the client 10. This must be one of the usernames suggested in the PK_sign_ack 190 message.

The password corresponding to the username.

The authentication and encryption headers. This message is authenticated and encrypted using the same keys as those used in the PK_sign message.

At this point, the client 10 stores the user credentials including the key pair, the username and password and the certificate of the application server 65 using the Store_key 210 message. Similarly, the application server 65 stores the Client's credentials in the database 70. The credentials include the username, password and certificate for the client 10. Accordingly, the stored key 210 and stored user credentials 220 can then be used for subsequent communication sessions between client 10 and application server 65.

### Method 3: Self Generated Root Keys

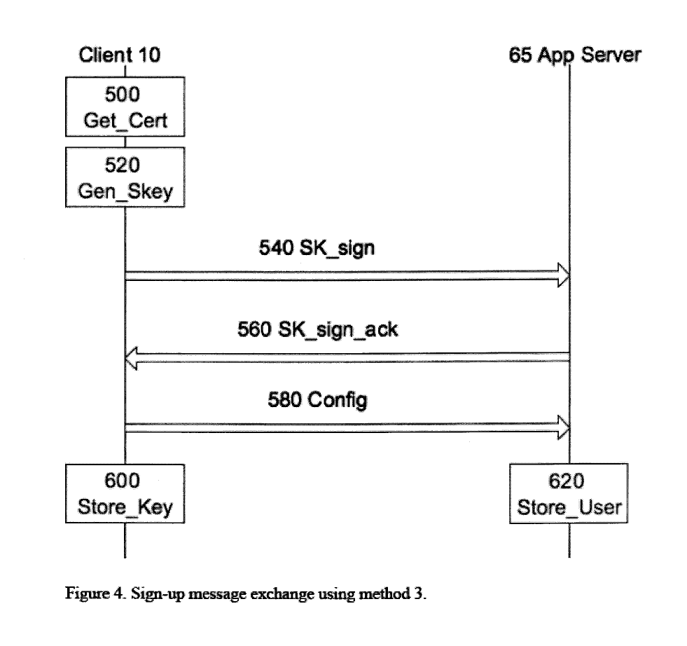

This method allows the client 10 to sign-up with the application server 65 without using public keys but by assuming that the application server 65 has a public key pair and a certificate that the client can retrieve. FIG. 4 illustrates the message exchange needed for doing the sign-up procedure using this method.

In this method, the Client 10 starts with the same procedure as in method 2 by retrieving the application's certificate using the Get_Cert 500 procedure. Following this, the client generates a Root key. The Root key is used to establish a permanent security relation between the client 10 and the application server 65. Following the generation of a Root key, the client 10 sends the SK_sign 540 message to the application server 65.

The message contains the following parameters:

The Root key generated by the client 10 in the Gen_key 520 procedure.

The user's information form. This form includes including billing method, credit card information, and so on. This information may be manually input by the user through an application interface on the client 10.

A requested username to be associated with the Root key. This is a suggestion that may be accepted or rejected by the application receiving this message.

A requested password. The client should ensure that the password complies with the receiving application's requirements for password formats.

Encryption header. The message is encrypted by the public key of the application server 65, which was received after the get_cert 160 procedure.

Upon processing the SK_sign 540 message, the application server 65 sends the SK_sign_ack 560 message. This message contains the following information:

Indication of success or failure

The accepted username. This parameter indicates whether the username sent by the client 10 was accepted. If that username was not accepted, a list of suggested usernames is sent in this parameter. The client 10 can then choose to accept one of those suggested names or re-send the SK_sign message again. If one of the suggested usernames were accepted, it will be included in the Config 580 message.

The authentication method that should be used by the client in future to start a secure session. Such method may indicate, for example, EAP methods, The Internet Key Exchange (IKE) (RFC 4306) or any other proprietary method.

The authentication and encryption headers. This message is authenticated and encrypted the Root key of the client 10, which was sent in the SK_sign 540 message.

Upon receiving the SK_sign_ack 560 message, the client 10 sends the Config 580 message to the application server 65. The message contains the following parameters:

The username accepted by the client 10. This must be one of the usernames suggested in the SK_sign_ack 560 message.

The password corresponding to the username.

The authentication and encryption headers. This message is authenticated and encrypted using the Root key generated by the client.

Accordingly, the stored key 600 and stored user credentials 620 can then be used for subsequent communication sessions between client 10 and application server 65.

### Using Multiple Clients

A user may wish to connect to the app server 65 using multiple client devices. Each device may be provided different security credentials depending on the mechanism used at sign-up. In this case, it is essential that the new clients' credentials are associated with the same user's identity in order to have access to the same set of data stored on the database.

To achieve this goal, the user can use its current, authenticated client to request a security credential (e.g. a large cookie or nonce) that can be used with another client to let the application server 65 know that the same user is using two different clients, and therefore, the different client credentials should be associated with the same user.

When the user attempts to contact the app server 65 using a new client, the new client will include the nonce provided to the other client in order to prove that it's action is on behalf of the same user. The new client performs the same sign-up procedure and includes the nonce retrieved from the old client in the user information form sent in the relevant sign-up message (depending on which of the methods above is used). The nonce provided by the app server could be presented to the user as a “license number” for ease of understanding since the user will likely input that nonce manually into the new client.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of generating information for secure data exchange with an application server, the method comprising:
performing, by a client device, an authentication with an authentication server of a wireless communication network;
sending, by the client device, a signup message to the application server, the signup message includes a signup form and a requested username;
receiving, by the client device, a signup acknowledgement message from the application server, the signup acknowledgement message includes an accepted username and a root key; and
storing, by the client device, the accepted username and root key, wherein the accepted username and root key are employed for secure data exchange with the application server, and the application server and client device do not have a prior security relationship.

2. The method of claim 1, further comprising:
generating, by the client device, an application-specific key using information obtained from the authentication with the authentication server.

3. The method of claim 2, wherein the application-specific key is generated by generating a hash value from a session key from the authentication with the authentication server and an application label.

4. The method of claim 2, wherein the authentication server generates an application-specific key using information obtained from the authentication with the authentication server and provides the application-specific key to the application server.

5. The method of claim 1, wherein the signup message includes a nonce.

6. The method of claim 1, wherein when the requested username is already reserved, the accepted username received in the signup acknowledgement message includes a list of suggested usernames.

7. The method of claim 1, wherein the signup form includes a billing method and payment information.

8. The method of claim 1, wherein the signup acknowledgement message also includes an authentication method for the secure data exchange.

9. The method of claim 1, further comprising:
requesting, by the client device from the application server, a security credential; and
providing the security credential to another client device, wherein the application server associates the another client device with a user of the client device.

10. The method of claim 9, wherein the another client device performs the acts of:
performing an authentication with the authentication server of the wireless communication network;
sending a signup message to the application server, the signup message includes a signup form, the requested username and the security credential;
receiving a signup acknowledgement message from the application server, the signup acknowledgement message includes the accepted username and the root key; and
storing the accepted username and root key, wherein the accepted username and root key are employed for secure data exchange with the application server.

11. A method of generating information for secure data exchange with an application server, the method comprising:
obtaining, by a client device, a certificate for an application associated with the secure exchange of data;
generating, by the client device, a key;
sending, by the client device to the application server, a signup message to an application server, the signup message including the generated key, a requested username and a requested password;
receiving, by the client device from the application server, a signup acknowledgement message, the signup acknowledgement message include an accepted username, an accepted password and a certificate for the secure data exchange.

12. The method of claim 11, wherein the key generated by the client device is a public key.

13. The method of claim 11, wherein the key generated by the client device is a root key.

14. The method of claim 11, wherein the signup message also includes a user information form.

15. The method of claim 14, wherein the user information form includes a billing method and payment information.

16. The method of claim 11, wherein when the requested username is already reserved, the accepted username received in the signup acknowledgement message includes a list of suggested usernames.

17. The method of claim 11, wherein the signup acknowledgement message also includes an authentication method for the secure data exchange.

18. The method of claim 11, further comprising:
requesting, by the client device from the application server, a security credential; and
providing the security credential to another client device, wherein the application server associates the another client device with a user of the client device.
